(19) United States
(12) Patent Application Publication
(10) Pub. No.: US 2024/0424970 A1
(43) Pub. Date: Dec. 26, 2024

(54) VEHICLE FOR THE AUTOMATED TRANSPORT OF GOODS OR PRODUCTS

(71) Applicant: E-NOVIA S.P.A., Milano MI (IT)

(72) Inventors: Biagio FORESTIERI, Rivello PZ (IT); Mattia DE SANTIS, Tribiano MI (IT); Alberto Luigi COLOGNI, Osio Sopra BG (IT); Mattia VALLE, Milano MI (IT); Federico Lorenzo MORO, Milano MI (IT)

(73) Assignee: E-NOVIA S.P.A., Milano MI (IT)

(21) Appl. No.: 18/698,412

(22) PCT Filed: Oct. 6, 2022
(86) PCT No.: PCT/IB2022/059529

§ 371 Date: Apr. 4, 2024

(30) Foreign Application Priority Data
Oct. 7, 2021 (IT) 102021000025604

(51) Int. Cl. B60P 1/64; B60P 1/48; B60P 3/00; B66F 9/12

(52) U.S. Cl. CPC B60P 1/6427; B60P 1/483; B60P 3/007; B66F 9/122

(57) ABSTRACT

A vehicle for automated transport of goods or products described, which includes a container for holding goods or products to be transported and a manipulator assembly to pick up the goods and store them inside the container and remove the goods from the container. The manipulator assembly includes gripping means to grasp or carry the goods and handling means to move the gripping means along a first and second axis so that the movement along the first axis allows the gripping means to enter or leave the container through the container opening, while the movement along the second axis causes the gripping means to move towards or away from the container.

### TECHNICAL FIELD OF THE INVENTION

The present invention relates generally to the field of vehicles for transporting goods or products.

More specifically, the present invention relates to a vehicle for transporting one or more goods or products comprising a container capable of holding the goods or products to be transported and a manipulator assembly configured to pick up the goods or products to be transported and place them inside the container and to deposit the goods or products transported in the container outside, wherein the container is open on one side thereof and wherein a lid is mounted at that side of the container, said lid being movable between an open position, in which it leaves that side of the container open to allow entry of the goods or products to be transported into the container or exit of said goods or products from the container, and a closed position, in which it closes that side of the container to isolate the interior compartment of the container from the external environment.

### STATE OF THE ART

Vehicles are known for the automated delivery of one or more small products, which are either equipped with a compartment to house goods or products to be delivered or have a portion configured to secure the goods or products. Such vehicles are designed to move completely autonomously using route planning algorithms based on information acquired from high-precision sensors, typically lidar and video cameras. Once the destination is reached, various systems such as facial scans, QR codes, alphanumeric combinations, etc., allow identification of the user requesting access to the transportation compartment to verify that this user matches the predefined recipient. If such verification is successful, the transport compartment is opened to allow the user to collect the goods or products.

However, such known solutions require human intervention both in the phase of placing the product inside the vehicle and in the phase of withdrawing the product.

### SUMMARY OF THE INVENTION

It is an object of the present invention to provide a vehicle for transporting goods or products that allows the procedure of picking up and dropping off to be fully automated, without the need for human intervention.

This and other objects are fully achieved according to the present invention by a vehicle as defined in the attached independent claim 1.

Preferred embodiments of the vehicle according to the present invention are defined in the dependent claims.

In summary, the invention is based on the idea of providing a vehicle for transporting goods or products comprising a container for transporting one or more products that is open on one side thereof, a lid mounted at that side so as to be movable between an open position in which it leaves such side of the container open to allow entry or exit of the products to be transported inside the container, and a closed position, in which it closes the side of the container to isolate the interior compartment of the container from the outside environment, a manipulator assembly configured to pick up the products to be transported, to store them inside the container, to deposit outside the products being transported in the container, and to be housed inside the container when not in use, said manipulator assembly comprising gripping means configured to grasp and/or transport a product and handling means configured to handle said gripping means along at least a first axis and a second axis, wherein the handling along the first axis allows the gripping means to be released from the container or the introduction of the gripping means into the container through an opening provided in said side of the container, while the handling along the second axis produces an approach or departure of the gripping means with respect to the container.

Thanks to the presence of such a manipulator, the vehicle can autonomously pick up the product to be transported, place it inside the container to transport it to the desired destination, and finally take it out of the container to deliver it where required.

Moreover, due to the special configuration of the manipulator assembly, not only the goods or products being transported but also the manipulator assembly itself is entirely contained within the container during transport, thus remaining isolated from the external environment. This makes it possible to reduce the risk of exposure to contamination from the external environment, as well as allowing the goods or products contained within the container to be sanitized during transport. In addition, the fact that the manipulator assembly, along with the transported good or product, is entirely contained within the container during transport makes it safer to use the vehicle, as it avoids the risk of collisions with people who might be in the vicinity of the vehicle during its movement.

Additional features and advantages of the present invention will be evident from the following detailed description, given purely by way of non-limiting example.

### BRIEF DESCRIPTION OF THE DRAWINGS

In the following detailed description of the invention, reference will be made to the figures in the attached drawings, in which:

FIGS. 1 to 3 show a vehicle for transporting goods or products according to an embodiment of the present invention, each of such figures showing the vehicle under a different operating condition;

FIG. 4 shows the vehicle of FIGS. 1 to 3, without an outer cover, in the operating condition of FIG. 1;

FIG. 5 shows the vehicle of FIGS. 1 to 3, without the outer cover, in the operating condition of FIG. 3;

FIGS. 6 and 7 show in detail the manipulator assembly of the vehicle of FIGS. 1 to 3, in two different positions; and

FIG. 8 shows in detail, partially in section, the control mechanism for opening and closing the container lid of the vehicle shown in FIGS. 1 to 3.

### DETAILED DESCRIPTION OF THE INVENTION

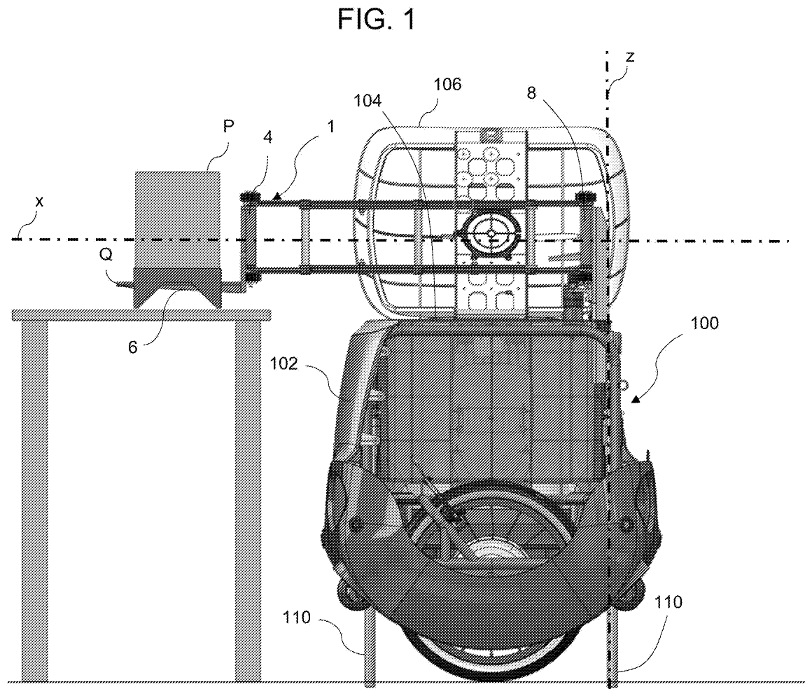

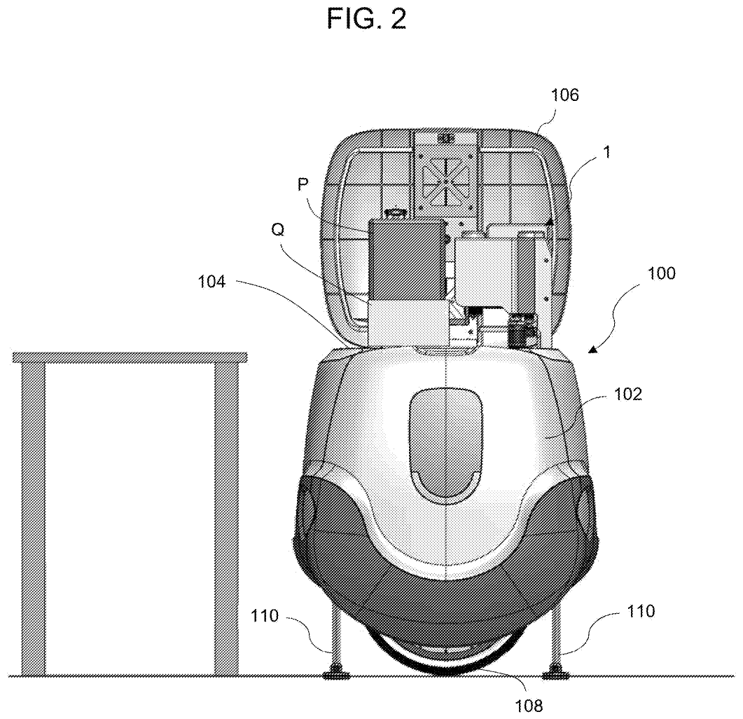

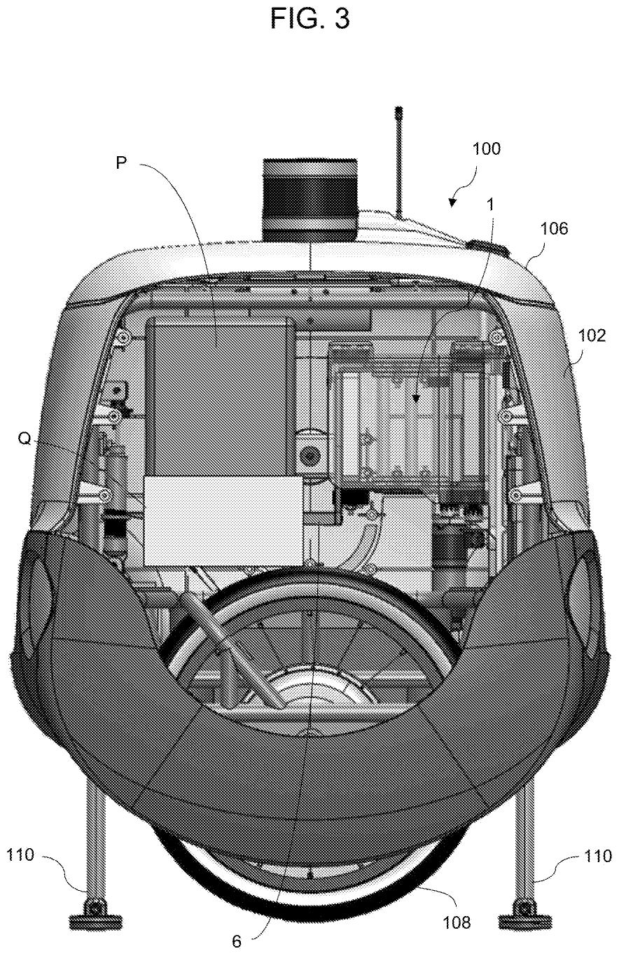

Referring initially to FIGS. 1 to 3, a vehicle for transporting goods or products according to the present invention is generally indicated 100. The vehicle 100 basically comprises:
a container 102 suitable for holding the good or product to be transported (shown schematically in FIGS. 1 to 3, where it is denoted by P), the container 102 having an opening 104 on one of its sides, which in the present case is the top side but could also be a front side or another side;
a lid 106 mounted at said side of the container 102 so as to be movable between an open position (FIGS. 1 and 2), in which it leaves the opening 104 open to allow the entry of good or product P into the container 102 or the exit of the good or product P from the container 102, and a closed position (FIG. 3), in which it closes the opening 104 to isolate the interior compartment of the container 102 from the external environment; and
a manipulator assembly 1 configured to take the good or product P to be transported and store it inside the container 102 and, vice versa, to deposit outside the good or product P transported in the container 102.

The manipulator assembly 1 first includes a gripper 6 configured to grasp and/or transport the good or product P. In the embodiment proposed herein, the gripper 6 is a fork, but may also be a gripper of another type, such as a suction cup gripper. In the case of the gripper 6 configured as a fork, as in the exemplary embodiment proposed here, the product P is preferably arranged on a platform Q having special seats for the insertion of the forks of the gripper 6. Such seats may, for example, have a triangular-shaped section so as to allow gripping even if the forks are not perfectly aligned with these seats.

The manipulator assembly 1 also includes a handling system configured to move the gripper 6 along a first axis z and along a second axis x, these axes being preferably perpendicular to each other. Movement along the first axis z allows the gripper 6 to exit the container 102 through the opening 104, while movement along the second axis x moves the gripper 6 closer to or further away from the product P to be picked up. In this regard, FIG. 1 shows the manipulator assembly 1 in the operating condition in which the gripper 6 engages the product P to be picked up, while FIG. 3 shows the manipulator assembly 1 in the operating condition in which the product P, still engaged by the gripper 6, is received inside the container 102. In the latter operating condition, not only the product P but the entire manipulator assembly 1 is accommodated inside the container 102, and the lid 106 simultaneously closes the opening 104.

However, the handling system may provide for additional degrees of freedom, either translational or rotational, such as a third degree of freedom of rotation about the first axis z.

In the exemplary embodiment proposed here, in which the opening 104 is placed on the upper side of the container 102, the first axis z is oriented vertically, so in the following description reference will be made to that specific orientation of the first axis z for convenience, even though this orientation, as well as the arrangement of the opening 104 on the upper side of the container 102, is not essential for the purposes of the present invention.

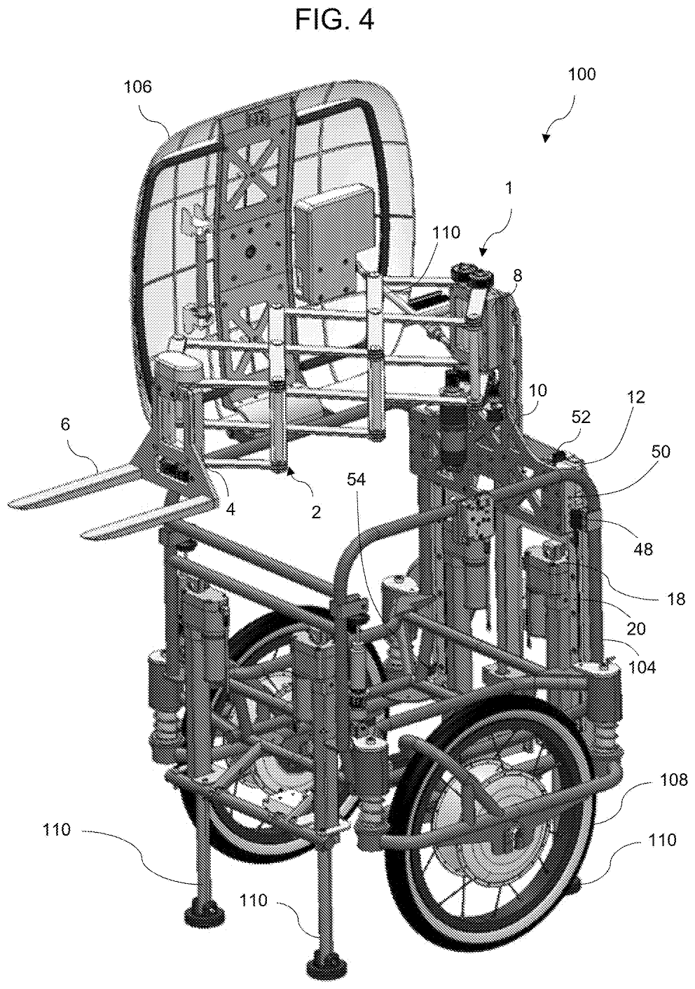

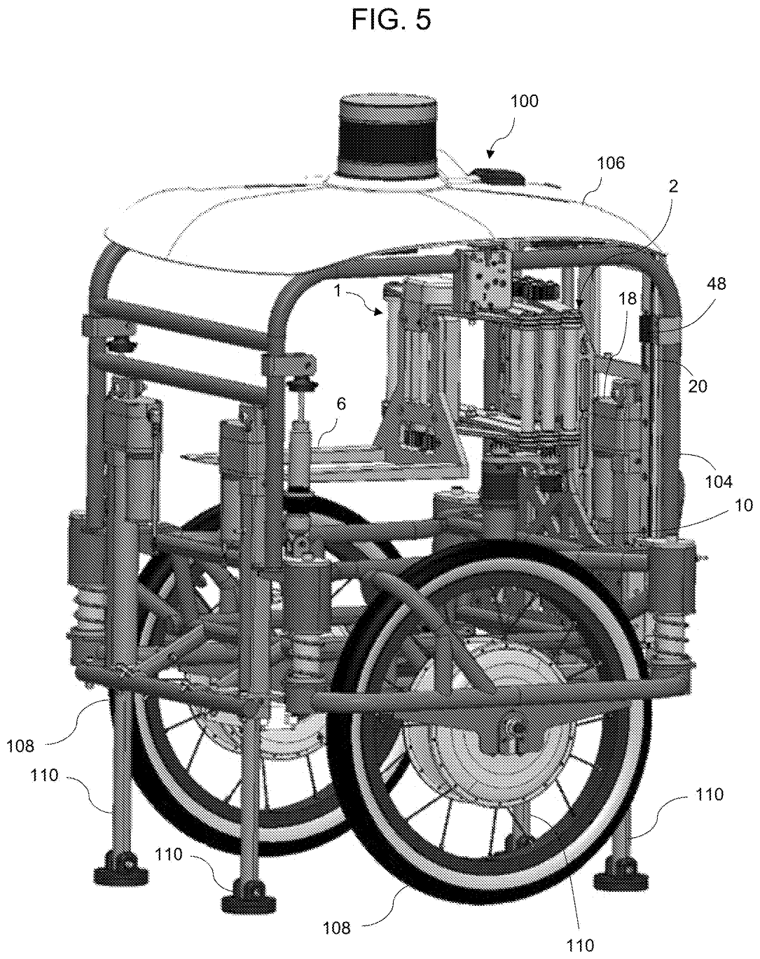

Referring now to FIGS. 4 and 5, the handling system of the manipulator assembly 1 includes a first drive assembly for controlling the movement of the gripper 6 along the first axis z and a second drive assembly for controlling the movement of the gripper 6 along the second axis x.

The second drive assembly comprises a pantograph mechanism 2, a distal end 4 of which is connected to the gripper 6 and is continuously movable between a plurality of operating positions along the second axis x, between a closed position (FIG. 5) and an extended position (FIG. 4). The first drive assembly is associated with a proximal end 8, opposite to the distal end 4, of the pantograph mechanism 2 to move the pantograph mechanism 2, and with it the gripper 6, continuously between a plurality of operating positions along the first axis z, between a first boundary position (in this case a lower boundary position) and a second boundary position (in this case an upper boundary position).

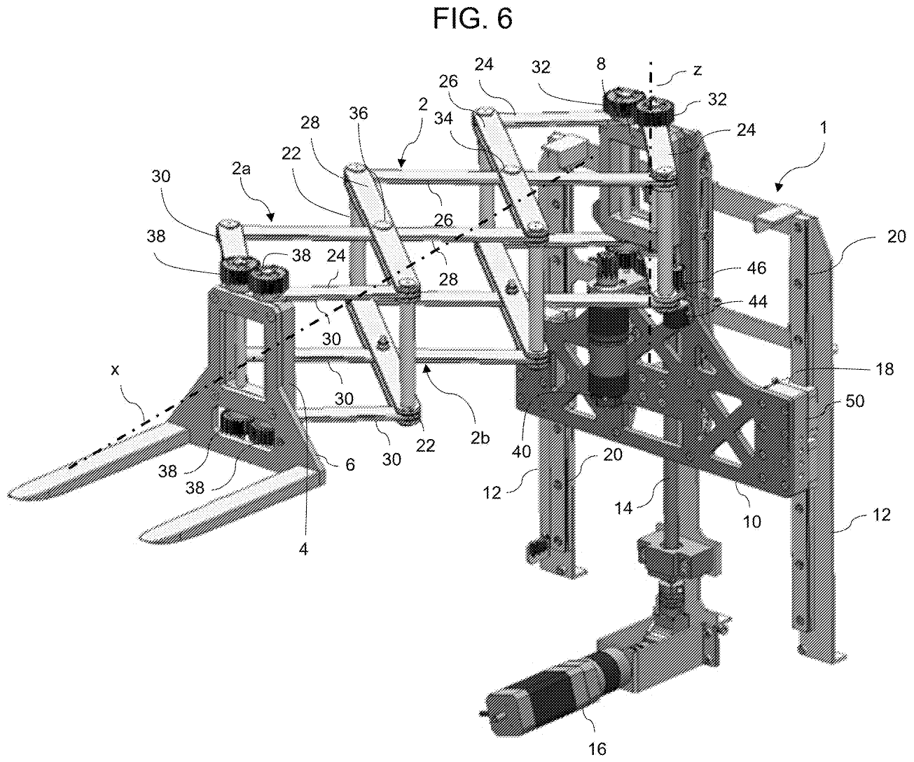

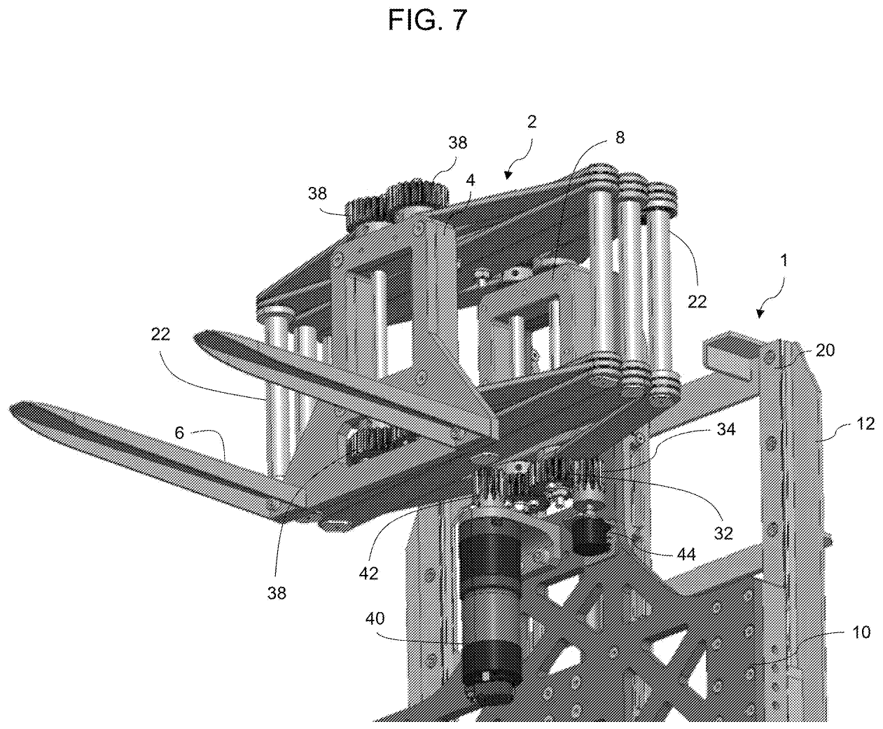

With reference also to FIGS. 6 and 7, the first drive assembly includes a slide 10 to which the proximal end 8 of the pantograph mechanism 2 is connected. The slide 10 is movably mounted, along the first axis z, on a support structure 12. For this purpose, the slide 10 is provided, at two of its lateral portions, with a pair of skids 18 that are slidably engaged with respective guide rails 20 carried by the support structure 12 and oriented along the first axis z, i.e., in the present case, vertically. The motion of the slide 10 along the guide rails 20 is controlled by a motor 16 by means of a motion conversion mechanism designed to convert the rotary motion generated by the motor 16 into a translational motion of the slide 10. Such a motion conversion mechanism is, for example, configured as a screw and nut mechanism comprising a worm screw 14, supported by the support structure 12 in a rotatable manner about an axis of rotation directed parallel to the guide rails 20 and driven into rotation by the motor 16, and a nut-screw (not shown) that is attached to the slide 10 and meshes with the worm screw 14 in such a way that rotation of the worm screw 14 about its axis of rotation, in one direction or the other, results in translational movement of the slide 10, and thus of the pantograph 2, along the first axis z, in one direction or the other. The motor 16 is preferably directed perpendicular to the worm screw 14 so as to reduce the footprint of the manipulator assembly 1 along the first axis z. It is to be understood that other actuation systems for generating the movement along the first axis z may be envisaged. For example, the slide might be moved by means of a belt, cable or rack-and-pinion mechanism.

Referring now specifically to FIGS. 6 and 7, the pantograph mechanism 2 comprises a pair of pantograph linkages 2a and 2b, upper and lower respectively, which are identical to each other and connected to each other by a plurality of rods 22 (which in this case are vertical rods, but more generally are rods directed perpendicular to the planes in which the two linkages lie). Such a structure provides the pantograph mechanism 2 with greater bending stiffness, thus allowing the transport of the product P without excessive deformation of the mechanism due to the weight of the product and the own weight of the mechanism.

Each linkage 2a, 2b comprises a plurality of levers connected to each other so as to rotate in a plane perpendicular to the first axis z, in the present case a horizontal plane. More specifically, each linkage 2a, 2b comprises, in order from the slide 10 to the gripper 6, a pair of drive levers 24, a pair of first transmission levers 26, a pair of second transmission levers 28 and a pair of end levers 30.

The drive levers 24 are provided at their proximal ends (i.e., the ends facing the slide 10) with respective gear wheels 32 meshing with each other in such a way that these levers rotate synchronously in opposite directions. The drive levers 24 of both linkage 2a and linkage 2b are mounted on a support body (corresponding to the aforementioned proximal end 8 of the pantograph mechanism 2) attached to the slide 10.

The first transmission levers 26 are hinged to each other by pins 34 at their respective midpoints. In addition, each first transmission lever 26 is hinged at one of its proximal ends to a distal end (i.e., the end facing the gripper 6) of a respective drive lever 24.

Similarly, the second transmission levers 28 are hinged to each other by pins 36 at their respective midpoints. In addition, each second transmission lever 28 is hinged at one of its proximal ends to a distal end of a respective first transmission lever 26.

Finally, each end lever 30 is hinged at one of its proximal ends to a distal end of a respective second transmission lever 28. Furthermore, the end levers 30 are provided at their distal ends with respective gear wheels 38 meshing with each other in such a manner that these levers rotate synchronously in opposite directions. The end levers 30 of both the linkage 2a and the linkage 2b are mounted on a support body (corresponding to the aforementioned distal end 4 of the pantograph mechanism 2), and to this support body is attached the gripper 6. Preferably, the support body to which the end levers 30 are mounted is identical to the support body to which the drive levers 24 are mounted.

It should be understood that the pantograph mechanism 2 described above may also take different, though functionally identical, forms. For example, the pantograph mechanism 2 might be rotated 90° from the configuration shown in the drawings, i.e., with the linkages 2a and 2b arranged in vertical rather than horizontal planes, or might include additional pairs of transmission levers in addition to the first transmission levers 26 and the second transmission levers 28.

The extension and retraction (or closing) movement of the pantograph mechanism 2 is driven by a motor 40 via a pinion gear 42 meshing with one of the gear wheels 32 attached to the drive levers 24, specifically with one of the gear wheels 32 attached to the drive levers 24 of the lower linkage 2b.

The use of a pantograph mechanism for the movement of the gripper 6 along the second axis x is particularly advantageous because it allows to obtain a considerable working stroke with a minimal footprint in the retracted or closed position. This allows the manipulator assembly 1 to be fully accommodated within the container 102 even in case the latter has small dimensions, such as dimensions that allow movement of the vehicle within closed spaces, such as aisles or halls of hospitals, stores, or factories.

However, other systems are possible to control the movement of the gripper 6 along the second axis x.

The manipulator assembly 1 is advantageously equipped with an electronic control unit (not shown) programmed to automatically control the handling system based on information from sensors associated with the first and second drive assemblies. Specifically, these sensors include a first sensor configured to provide the electronic control unit with first position signals representative of the position of the gripper 6 along the first axis z, and a second sensor configured to provide the electronic control unit with second position signals representative of the position of the gripper 6 along the second axis x.

For example, the second sensor includes a potentiometer 44 associated with a measuring wheel 46 that meshes with one of the gear wheels 32 associated with the drive levers 24 of the pantograph mechanism 2. Alternatively, the position of the gripper 6 along the second axis x may be sensed using an encoder associated with the motor shaft 40.

For example, the first sensor is made as a magnetic sensor 48 suitable for detecting the linear position along the first axis z of a magnet 50 integral with the slide 10. Also preferably provided, as shown in FIG. 4, are an upper limit switch 52 and a lower limit switch 54 suitable for detecting whether the slide 10 has reached an upper limit position and a lower limit position, respectively, in its movement along the first axis z. The magnetic sensor 48 is advantageously placed at an upper portion of the support structure 12 so as to measure the position of the slide 10 with greater accuracy as it approaches the upper limit position. Other examples of implementation for the first sensor are, of course, possible. The first sensor may, for example, be an encoder associated with the shaft of the motor 16 or the worm gear 14, or even be a laser sensor or an optical sensor capable of measuring the travel of the slide 10.

The vehicle 100 is preferably provided with wheels 108, particularly two wheels, for movement over land. In the case where only two wheels 108 are provided, the vehicle 100 preferably includes a plurality of motorized feet 110, for example four motorized feet 110, configured to be used during the manoeuvring of the manipulator assembly 1 to stabilize the vehicle.

The vehicle 100 is preferably a self-driving vehicle, and for this purpose it is equipped with appropriate sensors and an autonomous driving system (not illustrated here, but nonetheless of a type per se known).

According to an aspect of the invention, the vehicle 100 includes a UVC lamp (not shown) housed in the container 102 so that the outer surface of the transported product P can be sanitized during the movement of the vehicle 100.

In any case, regardless of the presence of the UVC lamp (or other sanitizing device), the fact that the product P to be transported can be contained within a closed compartment formed by the container 102 and the lid 106 makes it possible to avoid contamination of the product and ensure its safe transport.

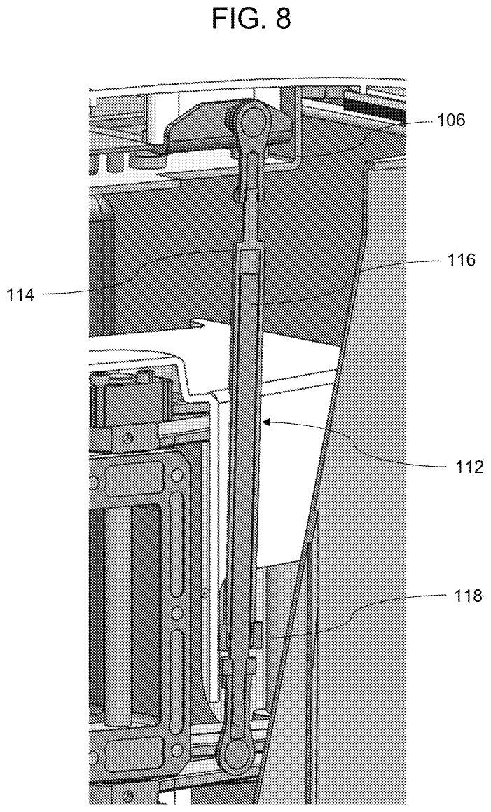

Referring finally to FIG. 8, the vehicle 100 preferably includes an automatic opening system for opening the lid 106 comprising a control rod 112 hinged on one side to the slide 10, or another component integral with it, and on the other side to the lid 106, so that the movement of the slide 10 along the first axis z from the lower limit position to the upper limit position causes the lid 106 to open progressively. More specifically, the rod 112 includes a first rod part 114, which is hollow, and a second rod part 116, which is solid and is accommodated within the first rod part 114. The first rod part 114 and the second rod part 116 are mutually constrained with respect to sliding due to the magnetic interaction between a magnet (not shown), which is contained within the first rod part 114, and a ferrous nut 118 attached around the second rod part 116. Applying a tensile force on the lid 106, and thus on the first rod part 114, allows the magnetic force of attraction between the magnet and the ferrous nut 118 to be overcome, thus decoupling the two rod parts 114 and 116. In this way, it is possible for an operator to open the lid 106 independently of the action of the second drive unit, that is, independently of the movement of the slide 10.

The present invention has been described herein with reference to a preferred embodiment thereof. It is to be understood that other embodiments may be envisaged that share the same inventive core of the invention herein described, as defined by the scope of protection of the following claims.

1. A vehicle for the transport of goods or products, comprising:
a container suitable for containing the goods or products to be transported, said container having an opening on one side thereof;
a lid mounted in the region of said opening of the container so as to be movable between an open position, in which it leaves said opening of the container open to allow the entry of said goods or products inside the container or the exit of said goods or products from the container, and a closed position, in which it closes said opening of the container to isolate the internal compartment of the container from the external environment; and
a manipulator assembly configured to pick up said goods or products and place them inside the container and to unload said goods or products transported in the container,
wherein the manipulator assembly comprises gripping means configured to grasp and/or transport said goods or products and handling means arranged to move said gripping means at least along a first axis (z) and along a second axis (x), in such a way that the movement along said first axis (z) allows the exit of said gripping means from the container or the introduction of said gripping means inside the container through said opening, while the movement along said second axis (x) causes said gripping means to move towards or away from the container, and
wherein said handling means are configured in such a way that the manipulator assembly is able to take a non-operative condition in which the manipulator assembly is entirely contained inside the container.

2. The vehicle according to claim 1, wherein said first axis (z) is perpendicular to said second axis (x).

3. The vehicle according to claim 1, wherein said first axis (z) is oriented vertically.

4. The vehicle according to claim 1, wherein said handling means comprise first actuation means arranged to control the movement of said gripping means along said first axis (z) and second actuation means arranged to control the movement of said gripping means along said second axis (x), wherein said second actuation means comprise a pantograph mechanism, a distal end of which is connected to said gripping means and is movable continuously to take a plurality of operating positions along said second axis (x), between a closed position and an extended position, and wherein said first actuation means are associated with a proximal end, opposite to said distal end of the pantograph mechanism, in order to control the movement of said proximal end of the pantograph mechanism, together with said gripping means, along said first axis (z).

5. The vehicle according to claim 4, wherein the manipulator assembly further comprises electronic control means configured to control said first actuation means and said second actuation means.

6. The vehicle according to claim 5, wherein the manipulator assembly further comprises first sensor means configured to supply said electronic control means with signals representative of the position of said proximal end of the pantograph mechanism along said first axis (z) and second sensor means configured to supply said electronic control means with signals representative of the position of said distal end of the pantograph mechanism along said second axis (x), said electronic control means being configured to control said first actuation means and said second actuation means on the basis of the signals received from said first sensor means and said second sensor means.

7. The vehicle according to claim 4, wherein the pantograph mechanism comprises a first and a second pantograph linkage, each in turn comprising a plurality of levers which extend in the same plane and are hinged to each other so as to rotate in this plane, and wherein the pantograph mechanism further comprises a plurality of rods which extend perpendicular to the plane of the first pantograph linkage and to the plane of the second pantograph linkage at hinge points between the levers of said first pantograph linkage and of said second pantograph linkage.

8. The vehicle according to claim 7, wherein said second actuation means further comprise a pair of gear wheels drivingly connected for rotation with a respective driving lever of said first pantograph linkage or of said second pantograph linkage and meshing with each other, and a motor arranged to drive one or the other of said gear wheels into rotation.

9. The vehicle according to claim 4, wherein said first actuation means comprise a slide carrying said proximal end of the pantograph mechanism, linear guide means associated with said slide to guide its translation movement along said first axis (z), and motor means associated with said slide to drive the translation movement thereof along said first axis (z).

10. The vehicle according to claim 9, wherein said motor means comprise a motor adapted to generate a rotary movement in one direction or the other and a motion conversion mechanism interposed between said motor and the slide and arranged to convert the rotary movement in one direction or the other generated by said motor into translational movement of the slide in one direction or the other along said first axis (z).

11. The vehicle according to claim 9, further comprising a control rod connected on one side to the slide and on the other to the lid to control the displacement of the lid from said closed position to said open position as a result of the movement of the slide in a direction such as to cause the exit of the pantograph mechanism from the container.

12. The vehicle according to claim 1, comprising a pair of wheels and a plurality of motorized feet configured to stabilize the vehicle during the manoeuvring of the manipulator assembly.

13. The vehicle according to claim 1, wherein said gripping means comprise a fork member.
